(19) United States
(12) Patent Application Publication
(10) Pub. No.: US 2026/0277539 A1
(43) Pub. Date: Sep. 17, 2026

(54) METHOD AND DEVICE FOR INTERACTING WITH A VOICE ASSISTANT DURING A CONFERENCE CALL

(71) Applicant: Tymphany HK Limited, Hong Kong (HK)

(72) Inventor: Yick Hong LAM, Taipei City (TW)

(21) Appl. No.: 19/315,146

(22) Filed: Aug. 29, 2025

Related U.S. Application Data
(60) Provisional application No. 63/769,887, filed on Mar. 11, 2025.

(51) Int. Cl. G06F 3/16; H04M 3/56

(52) U.S. Cl. CPC G06F 3/167; H04M 3/563

(57) ABSTRACT

A method for interacting with a voice assistant during a conference call is performed by a processor of a device that is participating in a conference call with one or more other devices. The method includes controlling the device to operate in a conference call state in which voice data received from a user is transmitted to the one or more other devices participating in the conference call; and in response to the device receiving non-verbal input from the user indicating that voice assistance is required, controlling the device to switch from operating in the conference call state to operating in a voice assistant state in which voice data received from the user is transmitted to a voice assistant and blocked from being transmitted to the one or more other devices participating in the conference call.

### CROSS REFERENCE TO RELATED APPLICATIONS

This application claims priority of U.S. Provisional Application No. 63/769,887 filed on Mar. 11, 2025 under 35 U.S.C. § 119(e), the entire contents of which are hereby incorporated by reference.

### TECHNOLOGICAL FIELD

The present disclosure relates generally to conference calling and, more particularly, to a method and device for interacting with a voice assistant during a conference call.

### BACKGROUND

A voice assistant is a type of technology that can listen to a user and perform tasks accordingly. A user may want to use a voice assistant while participating in a conference call. However, interacting with a voice assistant may disturb the conference call. Through applied effort, ingenuity, and innovation, the issue identified has been solved by developing solutions that are included in embodiments of the present disclosure, many of which are described in detail herein.

### SUMMARY OF THE INVENTION

Systems, devices, methods, and computer program products are disclosed herein for improved interaction with a voice assistant during a conference call.

An example method may be performed by a processor of a device that is participating in a conference call with one or more other devices. The method may comprise controlling the device to operate in a conference call state in which voice data received from a user is transmitted to the one or more other devices participating in the conference call. The method may further comprise in response to the device receiving non-verbal input from the user indicating that voice assistance is required, controlling the device to switch from operating in the conference call state to operating in a voice assistant state in which voice data received from the user is transmitted to a voice assistant and blocked from being transmitted to the one or more other devices participating in the conference call.

In some embodiments, the conference call state and the voice assistant state are states of a state machine.

In some embodiments, the state machine is defined in embedded software of the device.

In some embodiments, the state machine routes the voice data received from the user to voice processing circuitry of the device, wherein the voice processing circuitry processes the voice data using a first voice processing algorithm when the state machine is in the conference call state and processes the voice data using a second voice processing algorithm when the state machine is in the voice assistant state, wherein the second voice processing algorithm is different from the first voice processing algorithm.

In some embodiments, the method further comprises transitioning from the voice assistant state to the conference call state in response to input received from the user or automatically when a predetermined condition is met.

In some embodiments, the voice data transmitted to the one or more other devices participating in the conference call is transmitted via a conference call server.

In some embodiments, the voice data transmitted to the voice assistant is transmitted to a voice assistant server.

In some embodiments, the voice data received from the user in the voice assistant state contains a voice command representing a task to be performed by the voice assistant, wherein the task relates to the conference call.

In some embodiments, in the voice assistant state audio data of the voice assistant that is received by the device is also blocked from being transmitted to the one or more other devices participating in the conference call.

An example device may comprise a processor and memory storing instructions, which, when executed by the processor, cause the processor to: control the device to operate in a conference call state in which voice data received from a user is transmitted to one or more other devices participating in the conference call with the device; and in response to the device receiving non-verbal input from the user indicating that voice assistance is required, control the device to switch from operating in the conference call state to operating in a voice assistant state in which voice data received from the user is transmitted to a voice assistant and blocked from being transmitted to the one or more other devices participating in the conference call.

An example computer program product comprises at least one non-transitory computer-readable storage medium having computer-readable program code portions stored therein, the computer-readable program code portions comprising an executable portion configured to: control a device that is participating in a conference call with one or more other devices to operate in a conference call state in which voice data received from a user is transmitted to the one or more other devices participating in the conference call; and in response to the device receiving non-verbal input from the user indicating that voice assistance is required, control the device to switch from operating in the conference call state to operating in a voice assistant state in which voice data received from the user is transmitted to a voice assistant and blocked from being transmitted to the one or more other devices participating in the conference call.

The above summary is provided merely for purposes of summarizing some example embodiments to provide a basic understanding of some aspects of the disclosure. Accordingly, it will be appreciated that the above-described embodiments are merely examples and should not be construed as to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an environment in which some example embodiments described herein may be implemented.

FIG. 2 illustrates a block diagram of example device, in accordance with some example embodiments described herein.

FIG. 3 illustrates another block diagram block diagram of example device, in accordance with some example embodiments described herein.

FIG. 4 illustrates a state machine, in accordance with some example embodiments described herein.

FIG. 5 is a flowchart of a method, in accordance with some example embodiments described herein.

FIG. 6 is flowchart of another method, in accordance with some example embodiments described herein.

### DETAILED DESCRIPTION

Some embodiments of the present disclosure will now be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer a “device”. However, elements of the device described herein may be equally applicable to the claimed method and computer program product. Thus, use of any such terms should not be taken to limit the spirit and scope of embodiments of the present disclosure.

### Definition of Terms

As used herein, the terms “data,” “content,” “information,” “electronic information,” “signal,” “command,” and similar terms may be used interchangeably to refer to data capable of being processed, transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending (transmitting) data to a second computing device, it will be appreciated that the data may be sent (transmitted) directly to the second computing device or may be sent (transmitted) indirectly via one or more intermediary computing devices, such as, for example, one or more servers, remote servers, cloud-based servers (e.g., cloud utilities), relays, routers, network access points, base stations, hosts, and/or the like.

The use of the term "circuitry" as used herein includes particular hardware configured to perform the functions associated with respective circuitry described herein. Of course, while the term "circuitry" should be understood broadly to include hardware, the term "circuitry" may also include software for configuring the hardware. For example, although "circuitry" may include processing circuitry, storage media, network interfaces, input/output devices, and the like, other components may provide or supplement the functionality of particular circuitry.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

As used herein, the term “voice assistant” refers to digital assistant that can comprehend spoken commands and carry out corresponding tasks. A voice assistant may utilize technologies such as voice recognition to recognize spoken words, Natural Language Understanding (NLU) to interpret the meaning of the spoken words in their specific context (e.g., parse the speech for commands), and machine learning to learn from interactions to improve the accuracy and efficiency of the voice assistant. Perform a requested task may involve interacting with (e.g., controlling) other software and hardware. A voice assistant may be implemented at least in part by a cloud-based service. For example, a device may send voice data of a user to a remote server which may have more processing power to carry out the voice recognition, NLU, and machine learning processes. However, at least some of these tasks may be carried out locally at the device instead.

As user herein, the term “conference call” refers to a remote communication method and is intended to cover audio conferencing (only audio communication), video conferencing (audio conferencing with real-time video), and web conferencing which is similar to video conferencing except that certain participants are able to watch in real time but are not necessarily able to speak or be seen.

As used herein, the term “state machine” refers to a computation model representing a system with a finite number of states. At any one time, the system can only be in one state. One or more executable actions may be attributed to each state and transitions between states may be triggered by specific inputs or events. A state machine may be implemented in hardware, software (e.g., embedded software), or a combination of hardware and software.

The term “embedded software” refers to software specifically designed to control and manage an embedded system that has a specific function to perform (whereas a general-purpose computer can perform a wide range of functions). An embedded system may be part of a larger system, though an embedded system can also serve as a standalone device. An embedded system may be implemented as a microprocessor- or microcontroller-based system or any other suitable system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used herein to mean “serving as an example, instance, or illustration.” Any implementation described herein as “example” is not necessarily to be construed as preferred or advantageous over other implementations.

Having set forth a series of definitions called-upon throughout this application, an example system architecture and example apparatus is described below for implementing example embodiments and features of the present disclosure.

### Example Device

Conference calling has become a prevalent form of business communication. At the same time, many businesses are utilizing voice assistants to improve productivity. These technologies intersect when, for example, a user wants to use a voice assistant during a conference call to perform certain tasks without the need to navigate through menus or use a mouse, such as initiating or halting screen sharing, navigating slides, opening a chat window, muting or unmuting other participants, and so on. However, doing so may create unwanted noise and distraction during the conference call.

To solve these issues and others, an example method of the present disclosure comprises operating a device in a conference call state in which voice data received from a user is transmitted to the one or more other devices participating in a conference call with the device; and in response to the device receiving non-verbal input from the user indicating that voice assistance is required, switching from operating in the conference call state to operating in a voice assistant state in which voice data received from the user is transmitted to a voice assistant and blocked from being transmitted to the one or more other devices participating in the conference call. In doing so, embodiments of the present application may ensure that a conference call is not disrupted when a user interacts with a voice assistant during the conference call.

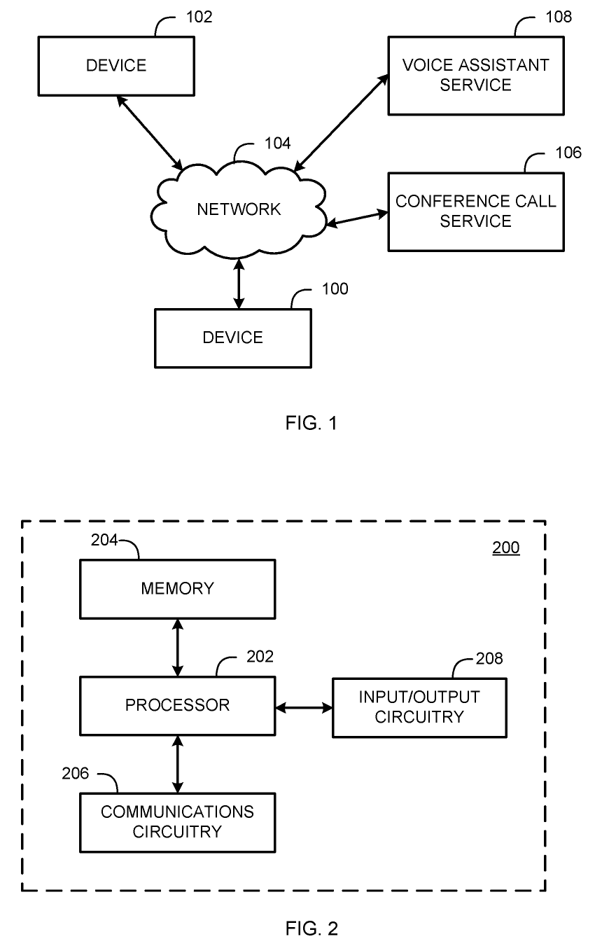

With reference to FIG. 1, a device 100 (e.g., a conference call device) according to embodiments of the disclosure is illustrated communicably connected via a network 104 to another device 102 with which the device 100 is participating in a conference call. For ease of visual clarity, only one other device 102 is shown but it will be appreciated that there may be more devices participating in the conference call.

As shown in FIG. 1, the device 100 may be communicably connected via the network 104 to a conference call service 106 (e.g., cloud-based server or other device, and which may also be referred to as a conference call bridge or a conference call server). Conference call capabilities may therefore be implemented, at least in part, by a cloud-based service. Examples of cloud-based conference call services include Zoom, Webex, GoToMeeting, Microsoft Teams, and Google Meet. The device 100 may also be communicably connected via the network 104 to a voice assistant service 108 (e.g., cloud-based server or other device). Voice assistant capabilities may therefore be implemented, at least in part, by a cloud-based service. Examples of cloud-based voice assistant services include Amazon Alexa, Google Assistant, Apple Siri, and Microsoft’s Cortana. Thus, when both a cloud-based conference call service and a cloud-based voice assistant service are employed, the device 100 may, for example, transmit voice data to the voice assistant service 108 for processing and carrying out a task. The task may relate to a conference call taking place between the devices 100, 102 via the conference call service 106. Of course, an offline voice assistant which processes voice data locally on the device 100 is also contemplated. Likewise, devices 100, 102 may participate in a conference call without the need for the conference call service 106.

A server on which the conference call service 106 or the voice assistant service 108 may be implemented may include circuitry, networked processors, or the like configured to perform various processes described herein and may be any suitable network server and/or other type of processing device. Such a server may be located remotely from the device 100. Such a server may comprise several servers or computing devices performing interconnected and/or distributed functions. Therefore, such a server may be configured as a locally-hosted server, a cloud-based, distributed server, or a peer-to-peer network.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, 3G, 4G, 5G, and/or WiMAX network. Furthermore, the network 106 may include a public network, such as the Internet, a private network, such as an intranet, or combinations thereof, and may utilize a variety of networking protocols now available or later developed including, but not limited to TCP/IP based networking protocol.

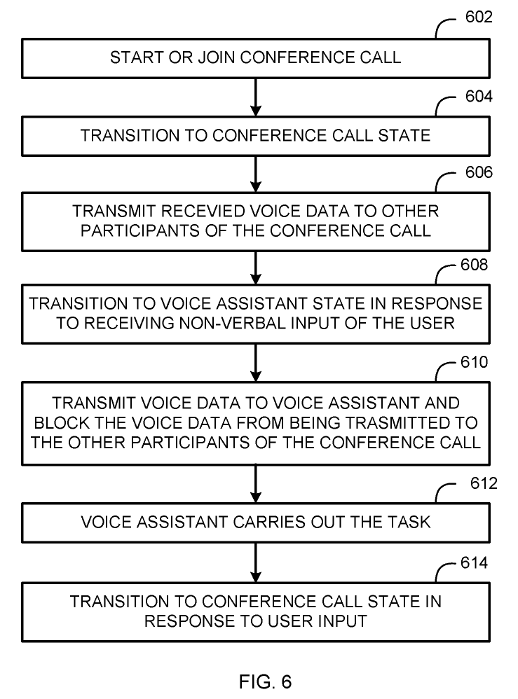

FIG. 2 is a block diagram of a device 200 (e.g., the device 100 shown in FIG. 1) according to embodiments of the disclosure and which may be configured to execute the operations described below in connection with FIGS. 5 and 6. The device 200 may include a processor 202, a memory 204, communications circuitry 206, and input/output circuitry 208. The processor 202 may be in communication with the memory 204 via a bus for passing information among components of the device 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the device 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term "processor" may therefore be understood to include a single core processor, a multi-core processor, multiple processors internal to the device 200 and/or remote or "cloud" processors. In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed. In some embodiments, the processor 202 may be implemented as a microcontroller (i.e., a microprocessor with integrated memory and peripheral interfaces), a microprocessor using external chips for memory and peripheral interface circuits, an ASIC, a DSP, etc. and this may be the case when the device 200 is a dedicated conference call device.

The device 200 may further include input/output circuitry 208 that may, in turn, be in communication with processor 202 to provide output to a user and to receive input from a user, user device, or another source. In this regard, the input/output circuitry 208 may comprise a display that may be manipulated by a user. In some embodiments, the input/output circuitry 208 may also include additional functionality such as a keyboard, a mouse, a touch screen, touch areas, soft keys, a microphone, a speaker, or other input/output mechanisms. The processor 202 and/or input/output circuitry 208 may be configured to control one or more functions of a display through computer program instructions (e.g., software and/or firmware) stored on a memory accessible to the processor (e.g., memory 204, and/or the like).

The communications circuitry 206 may be any means such as a device or circuitry embodied in either hardware or a combination of hardware and software that is configured to receive and/or transmit data from/to a network and/or any other device, circuitry, or module in communication with the device 200. For example, the communications circuitry 206 may be configured to establish a conference call session with another device. Furthermore, the communications circuitry 206 may be configured to establish a voice assistant session, i.e., a period when a voice assistant is active and listening for commands. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network (e.g., network 104 shown in FIG. 1). Additionally, or alternatively, the communication interface may include the circuitry for interacting with the antenna(s) to cause transmission of signals via the antenna(s) or to handle receipt of signals received via the antenna(s). These signals may be transmitted by the device 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, 3G, 4G, 5G, or the like. In addition, it should be understood that these signals may be transmitted using Wi-Fi, Near Field Communications (NFC), Worldwide Interoperability for Microwave Access (WiMAX) or other proximity-based communications protocols.

Furthermore, the communications circuitry 206 may allow the device 200 to be connected to another device (e.g., a dedicated conference call device connected to a laptop or to a display screen) either wirelessly or through a cable so that the operations described herein may be performed in a distributed manner by two or more devices.

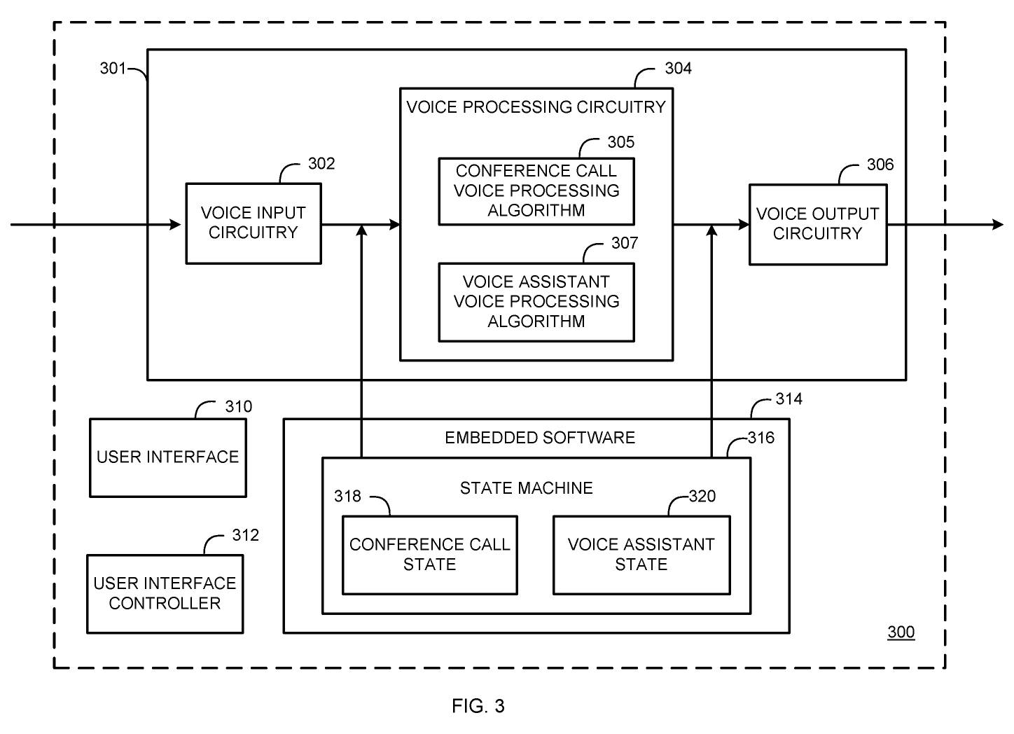

Although the device 200 may be implemented by a general-purpose computing device such as a laptop, mobile phone, tablet, desktop computer, and the like, in some embodiment the device 200 is implemented as a device in which the processor 202, memory 204, and input/output circuitry 206 have a specific function, i.e., implemented as an embedded system. An example of such a device is shown in FIG. 3.

The device 300 may include a signal processing pipeline 301. In the context of the present disclosure, a signal processing pipeline generally refers to the circuitry involved in receiving voice data, processing the voice data, and outputting the processed voice data to other participating devices of a conference call or to a voice assistant. As shown in FIG. 3, the signal processing pipeline 301 may comprise voice input circuitry 302, voice processing circuitry 304, and voice output circuitry 306.

In the context of a conference call, the signal processing pipeline 301 may acquire voice data of a user of the device 300, process the voice input to improve its quality and clarity (e.g., by applying noise reduction, equalization, compression, etc.), mix the voice data from different participating devices into one data stream, and route the voice data stream to the other participating devices of the conference call. It will be appreciated that at least some of these processes may be performed by another device (e.g., conference call service 106 in FIG. 1) and that the order of these processes may be changed. For example, voice input of the user may be acquired by the voice input circuitry 302 (e.g., a microphone which may be an example of the input/output circuitry 208 in FIG. 2). The voice processing circuitry 304 may be configured to process the voice data to improve its quality. The voice output circuitry 306 (e.g., communications circuitry 206 in FIG. 2) may be configured to encode the voice data in a suitable format and transmit it to the other participating devices of the conference call via a conference call service (e.g., conference call service 106 in FIG. 1). Thus, the process of mixing the voice data from the device 300 with voice data of other participating devices may be carried out by external to the device 300, though this need not be the case. Furthermore, it will be appreciated that the voice processing carried out by voice processing circuitry 304 may instead be carried out instead by a different device (e.g., conference call service 106 in FIG. 1).

In the context of voice assistant functionality, the signal processing pipeline 301 may acquire voice data of a user of the device 300, process the voice data to improve the quality of the voice data, and output the voice data to a voice assistant for subsequent processing (e.g., voice recognition, NLU, and machine learning processes). For example, voice data may be acquired by the voice input circuitry 302 (e.g., a microphone, which may be the same device as that used to acquire voice data from the user for the conference call). The voice processing circuitry 304 may be configured to process the voice data to improve its quality, and the audio output circuitry 306 may be configured to encode the voice data in a suitable format and transmit it to a voice assistant which may be implemented at the device, at another de (e.g., voice assistant service 108 in FIG. 1 or a voice assistant implemented at the device 300). Regardless of where it is implemented, a voice assistant may cause the device 300 to carry out tasks in response to voice commands of the user.

In some embodiments and as shown in FIG. 3, the voice processing circuitry 304 comprises a conference call voice processing algorithm 305 and a voice assistant voice processing algorithm 307. This may allow the device 300 to specifically process voice data according to the intended use. For example, clarity of sound may be of utmost importance for conference calls. Voice data for the conference call may therefore be processed by a conference call voice processing algorithm 305 to enhance clarity. On the other hand, it may be more important for a voice assistant to reliably understand the voice data. Voice data for the voice assistant may therefore be processed by the voice assistant voice processing algorithm 307 to normalize the voice data for consistency and remove silences to enable the voice recognition process to be more computationally efficient. Furthermore, at least some of the subsequent processing (e.g., voice recognition) may be performed by the device 300. Accordingly, the conference call audio processing circuitry 305 and the voice assistant audio processing circuitry 307 may implement different voice processing algorithms which may be tailored for the specific purpose even if there is an overlap of some of the requirements (e.g., reducing noise). Such algorithms may comprise machine learning algorithms that may be trained on different training data. Of course, the voice processing circuitry 304 may employ the same algorithm(s) for processing voice data of the conference call and for processing voice data of the voice assistant. Any suitable processing algorithms may be utilized for the aforementioned purposes.

The device 300 may also include a user interface 310 and a user interface controller 312. The user interface 310 may be configured to receive non-verbal input from a user of the device 300 and may comprise, for example, one or more mechanically actuated buttons and/or one or more non-mechanically actuated buttons such as virtual buttons on a touch-sensitive user interface (e.g., touch screen), a mouse, a camera to capture a gesture of the user, or any other suitable device to receive non-verbal input from a user. The user interface 310 may be integrated with the device 300 or communicably connected (wirelessly or wired) to the device 300. The inputs received at the user interface 310 may be processed by user interface controller 312 including, for example, interpreting the user input.

Although no video functionality (e.g., video output circuitry and video processing circuitry) is shown in FIG. 3, such functionality may be included in the device 300 or may be provided by another device that is connected to the device 300.

As noted earlier, voice data of a user that is to be processed by a voice assistant may not be intended to be heard by other participants of a conference call. Therefore, the device 300 may be configured to route voice data either to other participating devices of a conference call or to a voice assistant. When voice data is routed to the voice assistant it is blocked from being sent to the other participating devices of a conference call. In some embodiments, these capabilities may be implemented in the form a state machine 316 that is configured to transition between a conference call state 318 and a voice assistant state 320. As illustrated in FIG. 3, the state machine 316 may be implemented as embedded software but this need not necessarily be the case. The embedded software 314 may interface with the other components 301-312 of the device 300 in order to provide the aforementioned capabilities.

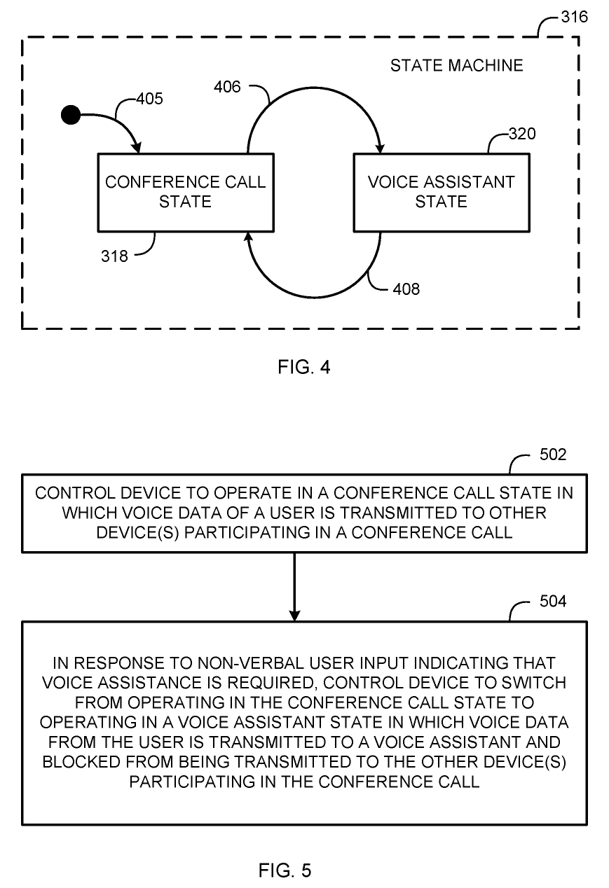

With reference now also to FIG. 4, the state machine 316 may start in an initial state denoted by the filled black circle, for example when the device 300 is powered on. Then, as denoted by arrow 405, the state machine 400 may transition to the conference call state 402 in response to a first trigger or event. The first trigger or event may be an indication that a conference call is to be held, e.g., when a user presses a conference call button on the device 300, when a conference call number is called, when the device 300 establishes a connection to a conference call service (e.g., conference call service 106 in FIG. 1), and so on. In the conference call state 402, the device 300 may be controlled to perform actions associated with a conference call such as transmitting voice data to other participating devices of the conference call.

As denoted by arrow 406, the state machine 316 may transition from the conference call state 318 to the voice assistant state 320 in response to a second trigger or event. In embodiments, the second trigger or event may comprise a non-verbal input of the user indicating that voice assistance is required. It may be, for example, a touch input, a text input, a pointer input, a gesture input, etc. The non-verbal input may be received by the user interface 310 and interpreted by the user interface controller 312. For example, in the case of a gesture input the user interface 310 may comprise a camera-based user interface and the user interface controller 312 may implement a gesture recognition algorithm. In the voice assistant state 320, the device 300 may be controlled to perform actions associated with a voice assistant such as routing voice data to a voice assistant (e.g., voice assistant service 108 in FIG. 1).

It is to be noted that in the voice assistant state 320 the device 300 may still perform actions associated with the conference call (an example of which is described with reference to FIG. 6) other than transmitting voice data to the other participating devices of the conference call. Said differently, the conference call is not paused or ended when the state machine 316 is in the voice assistant state 320. Rather, voice data (e.g., a voice command of the user intended for the voice assistant) is blocked from being sent to the other participating devices of the conference call. Other audio data such as audible alerts and notifications generated by the voice assistant may also be blocked from being sent to the other participating devices of the conference call. In this way, distractions to the conference call that may be caused by user interacting with the voice assistant may be reduced or eliminated.

As denoted by arrow 408, the state machine 316 may transition back to the conference call state 318 in response to a third trigger or event. This may be, for example, either a verbal input of the user or a non-verbal input of the user or may happen automatically when a predetermined condition is met, e.g., when the task associated with the voice commands has been completed. For example, when the task is to share a screen of the device and this has been completed, the state machine 316 may automatically transition back to the conference call state 318. This may alleviate the burden on the user.

The state machine 306 may control the routing of the voice data ‘upstream’ or ‘downstream’ of the voice processing circuitry 304. For example, if separate voice processing algorithms are implemented for processing voice data for the conference call and for the voice assistant, then the state machine 316 may intervene before the voice data is input to the voice processing circuitry 304 to ensure that the voice data is routed to the appropriate algorithm. In this case the processed voice data may be transmitted to the other participants of the conference call or the voice assistant without further intervention of the state machine 316 (though it may do so if needed). On the other hand, if the same algorithm(s) are implemented by the voice processing circuitry 304, then the state machine 314 may intervene only after the voice data has been processed by the voice processing circuitry 304.

The functions of the device have been described in the context of a state machine, which may have advantages such as reduced complexity and more predictable behavior since the states and the transitions are well-defined as well as ease of debugging and maintenance. They may also require less computational power and may therefore be well-suited for dedicated conference call devices. However, it will be appreciated that a device may be controlled to operate in a conference call state and a voice assistant state have the corresponding functionality without the use of a state machine.

### Example Operations

FIG. 5 illustrates a flowchart containing a series of operations in accordance with some example embodiments described herein. The operations illustrated in FIG. 5 may be performed by, with the assistance of, and/or under control of the device 200 shown in FIG. 2. In this regard, the operations may invoke the processor 202, the memory 204, the communications circuitry 206, and/or the input/output circuitry 208.

The method of FIG. 5 may be performed by a device that is participating in a conference call with one or more other devices.

At block 502, the device may be controlled to operate in a first state in which voice data received from a user is transmitted to the one or more other devices participating in the conference call.

At block 504, in response to the device receiving non-verbal input from the user indicating that voice assistance is required, the device switches from the first operating state to a second state in which voice data received from the user is transmitted to a voice assistant and blocked from being transmitted to the one or more other devices participating in the conference call. When the voice assistant is implemented at the device the transmission to the voice assistant may be an internal transmission within the device. Blocking the transmission of voice data may include, for example, removing the data from the transmission stream to the other participating devices, causing a break in the audio channel of the conference call, and the like.

The first state may be a first state of a state machine (e.g., conference call state 318 of state machine 316 described with reference to FIG. 3) and the second state may be a second state of the state machine (e.g., voice assistant state 318 that is described with reference to FIG. 3). Thus, the operations illustrated in FIG. 5 may be performed by, with the assistance of, and/or under control of the device 300 shown in FIG. 3. In this regard, the operations may invoke the signal processing pipeline 301, state machine 316, user interface 310, and/or the user interface controller 312.

FIG. 6 illustrates a flowchart containing a series of operations in accordance with some example embodiments described herein. The operations illustrated in FIG. 6 may be performed by, with the assistance of, and/or under control of the device 300 shown in FIG. 3.

At block 602, a conference call is started. This may trigger the state machine 316 to transition to the conference call state as indicated by block 604.

At block 606, while the state machine is in the conference call state, voice data from the user is transmitted to other participating devices of the conference call.

At block 608, a non-verbal input from the user indicating that voice assistance is required triggers the state machine to transition to the voice assistant state.

At block 610, while the state machine is in the voice assistant state, voice data representing a command of the user is sent to a voice assistant (e.g., voice assistant service 108 in FIG. 1). Meanwhile, this voice data of the user is blocked from being transmitted to the other participating devices of the conference call.

At block 612, the voice assistant carries out the task corresponding to the voice command. In some embodiments, the task may relate to the conference call. For example, the task may be to perform screen sharing, etc.

At block 614, an input from the user serves as a trigger to transition the state machine back to the conference call state. This input may be either a verbal input (since voice data is blocked from being transmitted to the other conference call participants in the voice assistant state) or a non-verbal input. For example, the verbal input may be a voice command (e.g., “turn off voice assistant”, “return to the conference call”, etc.) that may cause the voice assistant to trigger the state machine to return to the conference call state. Alternatively, the transition the state machine back to the conference call state may happen automatically.

### Conclusion

Many modifications and other embodiments set forth herein will come to mind to one skilled in the art to which this disclosure pertain having the benefit of the teachings presented in the foregoing descriptions and the associated drawings. Therefore, it is to be understood that this disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method performed by a processor of a device that is participating in a conference call with one or more other devices, the method comprising:
controlling the device to operate in a conference call state in which voice data received from a user is transmitted to the one or more other devices participating in the conference call; and
in response to the device receiving non-verbal input from the user indicating that voice assistance is required, controlling the device to switch from operating in the conference call state to operating in a voice assistant state in which voice data received from the user is transmitted to a voice assistant and blocked from being transmitted to the one or more other devices participating in the conference call.

2. The method of claim 1, wherein the conference call state and the voice assistant state are states of a state machine.

3. The method of claim 2, wherein the state machine is defined in embedded software of the device.

4. The method of claim 2, wherein the state machine routes the voice data received from the user to voice processing circuitry of the device,
wherein the voice processing circuitry processes the voice data using a first voice processing algorithm when the state machine is in the conference call state and processes the voice data using a second voice processing algorithm when the state machine is in the voice assistant state, and
wherein the second voice processing algorithm is different from the first voice processing algorithm.

5. The method of claim 2, further comprising transitioning from the voice assistant state to the conference call state in response to input received from the user or automatically when a predetermined condition is met.

6. The method of claim 1, wherein the voice data transmitted to the one or more other devices participating in the conference call is transmitted via a conference call server.

7. The method of claim 1, wherein the voice data transmitted to the voice assistant is transmitted to a voice assistant server.

8. The method of claim 1, wherein the voice data received from the user in the voice assistant state contains a voice command representing a task to be performed by the voice assistant, and
wherein the task relates to the conference call.

9. The method of claim 1, wherein in the voice assistant state audio data of the voice assistant that is received by the device is also blocked from being transmitted to the one or more other devices participating in the conference call.

10. A device, comprising:
a processor; and
a memory storing instructions, which, when executed by the processor, cause the processor to:
control the device to operate in a conference call state in which voice data received from a user is transmitted to one or more other devices participating in the conference call with the device; and
in response to the device receiving non-verbal input from the user indicating that voice assistance is required, control the device to switch from operating in the conference call state to operating in a voice assistant state in which voice data received from the user is transmitted to a voice assistant and blocked from being transmitted to the one or more other devices participating in the conference call.

11. The device of claim 10, wherein the conference call state and the voice assistant state are states of a state machine executed by the processor.

12. The device of claim 11, wherein the state machine is defined in embedded software of the device.

13. The device of claim 11, wherein the state machine routes the voice data received from the user to voice processing circuitry of the device,
wherein the voice processing circuitry processes the voice data using a first voice processing algorithm when the state machine is in the conference call state and processes the voice data using a second voice processing algorithm when the state machine is in the voice assistant state, and
wherein the second voice processing algorithm is different from the first voice processing algorithm.

14. The device of claim 1, wherein the state machine is configured to transition from the voice assistant state to the conference call state in response to input received from the user or automatically when a predetermined condition is met.

15. A computer program product comprising at least one non-transitory computer-readable storage medium having computer-readable program code portions stored therein, the computer-readable program code portions comprising an executable portion configured to:
control a device that is participating in a conference call with one or more other devices to operate in a conference call state in which voice data received from a user is transmitted to the one or more other devices participating in the conference call; and
in response to the device receiving non-verbal input from the user indicating that voice assistance is required, control the device to switch from operating in the conference call state to operating in a voice assistant state in which voice data received from the user is transmitted to a voice assistant and blocked from being transmitted to the one or more other devices participating in the conference call.
